(19) United States
(12) Patent Application Publication
(10) Pub. No.: US 2003/0222905 A1
(43) Pub. Date: Dec. 4, 2003

(54) Recipe recorder for automated chemistry

(75) Inventors: Craig R. Wierenga, Carmel, IN (US); Gregor Shih-Ji Hsiao, San Jose, CA (US); Timothy Watson, Waterford, CT (US); Peter Robert Rose, Ledyard, CT (US)

Correspondence Address: RUSSELL E. FOWLER, II, ICE MILLER, ONE AMERICAN SQUARE, BOX 82001, INDIANAPOLIS, IN, 46282-0002, US

(73) Assignee: Argonaut Technologies, Inc., Foster City, CA

(21) Appl. No.: 10/162,272

(22) Filed: Jun. 4, 2002

(51) Int. Cl. G09G 5/00

(52) U.S. Cl. 345/744

(57) ABSTRACT

A recipe recorder for automated chemistry comprises an automated chemistry system that is capable of automatically recording every step taken by a chemist during a particular experiment and automatically replaying the steps to reproduce the experiment. The apparatus comprises a controller connected to a plurality of laboratory devices and an input/output device connected to the controller. A graphical user desktop is accessible through the input/output device for controlling the actions of the laboratory devices. In addition, the graphical user desktop includes a record option that allows the user to automatically record the actions of each laboratory device during an experiment and automatically stores the actions of each laboratory device in a computer program. The graphical user desktop also provides a playback option for executing the computer program to automatically replay the recorded actions of the laboratory devices and thereby reproduce the experimental results in a subsequent experiment.

### BACKGROUND

1. Technical Field

The present invention relates to the field of automated chemistry and related laboratory devices.

2. Discussion

Automated chemistry systems that allow chemists to control experiments from a computer have been available for some time now. These systems typically include a computer providing a graphical display of the laboratory equipment to be used during the experiment. The chemist/user interacts with the graphical display to control the laboratory equipment from his or her computer desktop. When using such automated chemistry systems, the chemist/user may provide instructions to each piece of equipment on an “as needed” basis over the course of the experiment. Alternatively, the user may program a series of steps to be carried out by the laboratory equipment and then watch the computer execute the program so the experiment is performed automatically. Experiments that can be pre-programmed to run automatically are advantageous because the computers conducting the experiments are less prone to error than their human counterparts. Furthermore, automated experiments are advantageous because they free up valuable man-hours, allowing chemists to perform other valuable activities such as research.

Although tools are available for conducting experiments automatically, many chemists do not wish to plan an entire experiment in advance and program an automated chemistry system to automatically perform the experiment. Instead, chemists often wish to perform experiments on an ad hoc basis, with little planning in advance. In these situations, a chemist may use an automated chemistry system to control laboratory instruments, but instead of planning the entire experiment in advance, the chemist will perform the experiment extemporaneously. Accordingly, the chemist analyzes the progress of the experiment after each step and improvises to determine subsequent steps in an effort to produce a desired experimental result. For example, based on measurements such as temperature, pressure, or coloration observed during the experiment, the chemist may decide to take additional steps such as adding heat, pressure, or additional chemicals. If the chemist is successful, the aggregation of these steps will result in the desired experimental result.

After obtaining a desired experimental result, chemists often wish to reproduce those results. Fortunately, many automated chemistry systems automatically log data for each experiment undertaken using the automated chemistry system. The logged data provides the chemist with a list of actions taken during a particular experiment along with related measurements taken periodically throughout the experiment. If this data were not logged, the chemist would be required to take detailed notes during the experiment, or try to reconstruct the experiment entirely from memory, if the chemist wanted to reproduce the desired experiment results. However, because many automated chemistry systems automatically log data for each experiment, the chemist can use the logged data to reconstruct the experiment and reproduce the desired results. Nevertheless, if the chemist wishes for the results to be reproduced automatically, the chemist must attempt to program the automated chemistry system to automatically replay the previously conducted successful experiment.

Unfortunately, the process of programming automated chemistry systems is not entirely without problems. First, the programming process is time consuming and takes the chemist away from other valuable work. Second, if the chemist does not properly program the automated chemistry system, the same experimental results may not be reproduced by the new program. This is a source of frustration for chemists using automated chemistry systems, as the chemists must spend their valuable time attempting to program the machine to automatically reproduce the earlier achieved results. Furthermore, many chemists do not feel competent in trying to program the automated chemistry system, even with the most user-friendly programs. Thus, the chemists often ask third parties, such as computer technicians or lab assistants to program the automated chemistry system based on the logged data for the earlier experiment. Of course, these third parties are not as familiar with the experiment as the chemist who conducted the experiment, and do not always interpret the logged data correctly. A computer technician asked to program a particular experiment into the automated chemistry system may not have sufficient knowledge of the experimental process to properly interpret the logged data and program the system to reproduce the experimental results. Therefore, in addition to costing additional man-hours, use of third party programmers does not guarantee identical experimental results when attempting to automatically replay an earlier experiment.

For the foregoing reasons there is a need for a laboratory product that is capable of automatically recording every step taken by a chemist during a particular experiment and then automatically replaying the steps to automatically reproduce the experimental process. This would allow the chemist the freedom to work without manually recording every step of the experimentation process. Once an experiment is completed, the results could be stored and reproduced by the automated chemistry system, without assistance from the chemist that performed the experiment.

### SUMMARY

The present invention is directed to a method and apparatus that satisfies the need for a laboratory product that is capable of automatically recording every step taken by a chemist during a particular experiment and then automatically replaying the steps to automatically reproduce the experimental process. The apparatus comprises a controller connected to a plurality of laboratory devices and an input/output device connected to the controller. A graphical user desktop is accessible through the input/output device for controlling the actions of the plurality of laboratory devices. The graphical user desktop comprises representations of the plurality of laboratory devices, allowing the user to easily understand and view the laboratory arrangement during an experiment. Dialog boxes are provided through the graphical user desktop to allow the user to prescribe parameters for operation of each of the laboratory devices. The controller operates the laboratory devices according to the prescribed parameters entered into the dialog boxes. Accordingly, the user is able to conduct an experiment and produce associated initial experimental results using the graphical user desktop. Furthermore, the graphical user desktop includes a record option that allows the user to automatically record the actions of the plurality of laboratory devices during the actual experiment and automatically stores the actions of each laboratory device in a computer program. The graphical user desktop also provides a playback option for executing the computer program to automatically replay the recorded actions of the plurality of laboratory devices and thereby reproduce the experimental results in a subsequent experiment. These and other features, aspects, and advantages of the present invention will become better understood with reference to the following description and appended claims.

### BRIEF DESCRIPTION OF THE DRAWINGS

FIG. 1 is a block diagram showing hardware connections between several elements of an automated chemistry system.

FIG. 2 is an exemplary reactor used in the automated chemistry system of FIG. 1;

FIG. 3 is a preferred embodiment of a graphical user desktop for an automated chemistry system, including a record option for recording actions taken during an experimental process;

FIG. 4 is a dialog box of the graphical user desktop of FIG. 3;

FIG. 5 is a recipe editor of the graphical user desktop of FIG. 3;

FIG. 6 is another view of the recipe editor of FIG. 5;

FIG. 7 is a dialog box of the graphical user desktop of FIG. 3.

### DESCRIPTION

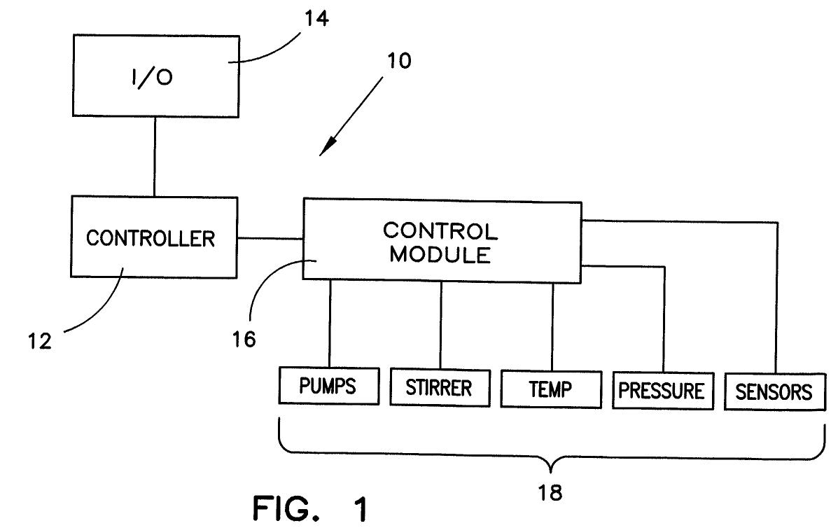

The present invention is an automated chemistry system having the ability to record and automatically replay the actions of laboratory devices occurring during a laboratory experiment. With reference to FIG. 1, the automated chemistry system 10 includes a controller 12, input/output device 14, control module 16, and various laboratory instruments/devices 18. The controller 12 is preferably a personal computer with an operating system such as WINDOWS® NT that allows for graphical program manipulation. The input/output device 14 is connected to the controller 12 and allows the user of the automated chemistry system 10 to interact with the controller 12. The input/output device 14 typically includes a keyboard, monitor, mouse, speakers and/or other input/output devices used in association with computers such as microphones, touch screens, trackballs, etc. Also connected to the controller 12 is the control module 16, which comprises a number of interface boards/cards that allow the controller to communicate with the laboratory devices. To this end, the boards of the control module 16 monitor the laboratory devices 18 and pass information about the laboratory devices on to the controller 12. In addition, the boards of the control module 16 pass signals from the controller 12 on to the laboratory devices 18 to control the operation of the laboratory devices. The laboratory devices 18 may include pumps, stirrers, heaters, coolers, vacuum devices, temperature monitors, pressure monitors, and other sensors and laboratory instruments. Furthermore, the term “laboratory devices” as used herein may refer to any number of devices used in chemical processes, regardless of size, and regardless of whether the device is or can be used in a traditional “laboratory” setting.

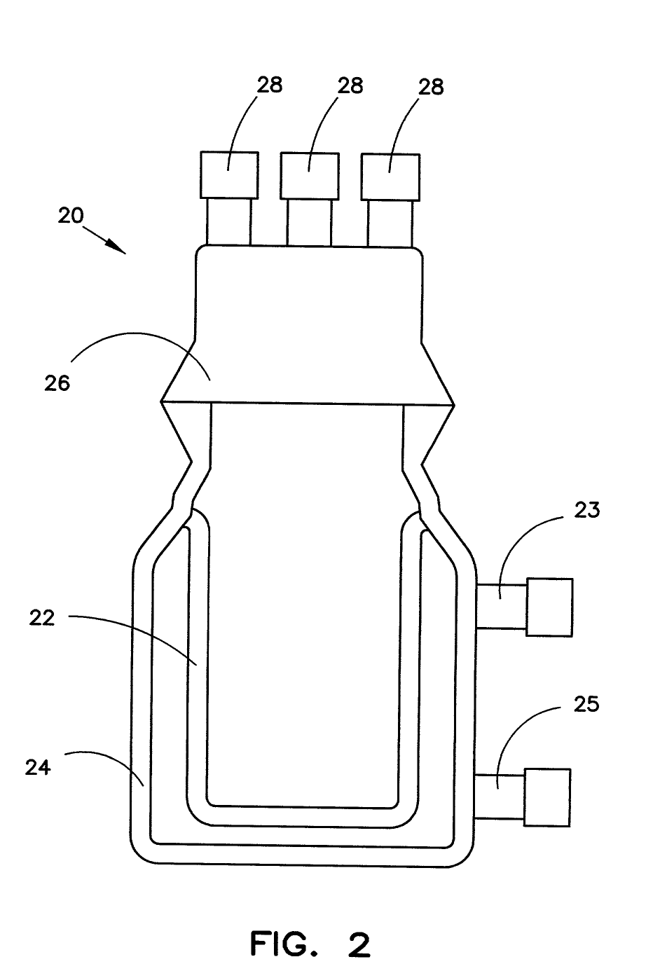

Operation of the laboratory devices 18 generally results in an action directed to reaction materials within a reactor. Alternatively, operation of the laboratory devices 18 may provide information about the reaction materials in the reactor. The reactor may take a number of different forms, but an exemplary reactor used in many automated chemistry systems 10 is shown in FIG. 2. As shown in FIG. 2, the reactor 20 includes a glass reactor interior 22 for holding reaction materials/mixtures. The reactor interior 22 is contained within a glass reactor jacket/shell 24. The reactor jacket 24 includes a jacket inlet 23 and a jacket outlet 25. The jacket inlet 23 allows fluid to enter the space between the reactor interior 22 and the reactor jacket 24 and exit out the jacket outlet 25. A glass reactor head 26 covers the top of the reactor interior 22, and forms a seal between the reactor head 26 and the reactor interior 22. The head 26 includes a number of ports 28 which provide passages between the reactor interior and the outside of the reactor.

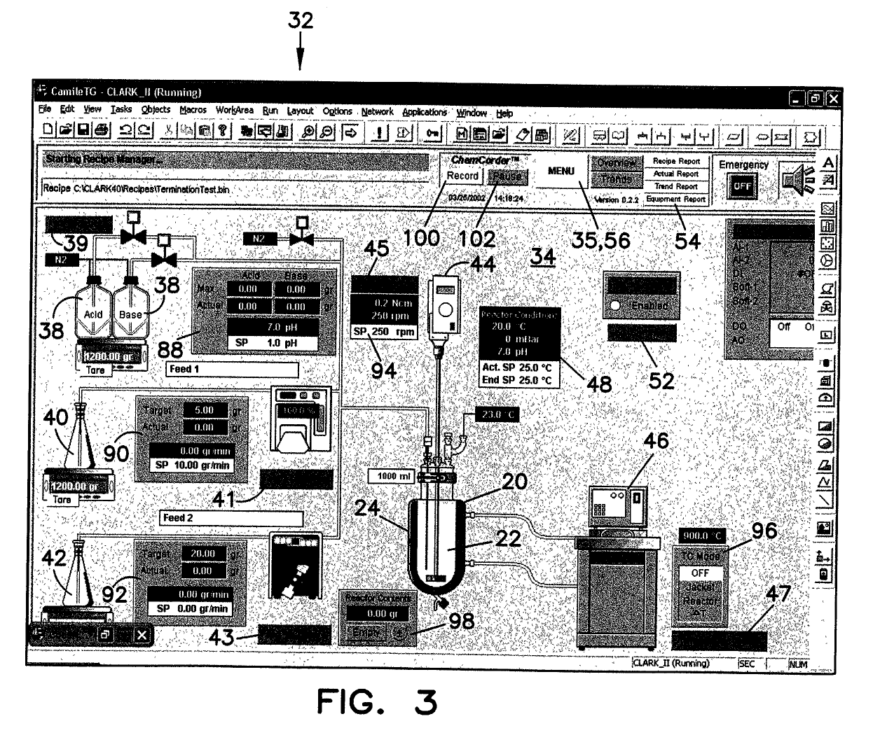

The automated chemistry system utilizes software stored in either the control module 16 or the controller 12 to provide a graphical user desktop 32 for controlling the laboratory devices. The graphical user desktop 32 may be accessed by the user through the input/output device 14. As shown in FIG. 3, the graphical user desktop 32 includes an overview screen 34 that displays graphical representations of the reactor and associated laboratory devices used to carry out a desired experiment. The graphical user desktop may also include several other screens and pull down menus. Examples of such other screens and pull down menus are described herein and include, but are not limited to, the recipe editor screens and pull down menus described herein. In the embodiment shown in FIG. 3, the overview screen 34 of the graphical user desktop 32 displays a reactor 20, a pH control system 38, a first chemical feed 40, a second chemical feed 42, a stirrer 44, a temperature control system 46, and a summary of reactor conditions box 48. Of course, other laboratory instruments may be included on the overview screen if they are required for a particular experiment. The user has the ability to set up the graphical user desktop to properly represent all instruments used in a particular experiment.

The graphical user desktop 32 allows the user to easily see how the instruments 18 associated with the reactor 20 are arranged and monitor the progress of an experiment from the overview screen 34. The graphical user desktop 32 also provides the user with the ability to control each of the laboratory devices 18 used in the experiment directly from the screen. Accordingly, the automated chemistry system 10 allows the user to conduct an experiment by commanding one instrument after another to take certain actions, thereby orchestrating the experiment step-by-step, in real-time, from the desktop 32. Alternatively, as explained in more detail below, the user may program the system to run independent of human operation, and thereby leave the desktop while the experiment is automatically carried out unattended by a human operator.

Real Time Experiment Control

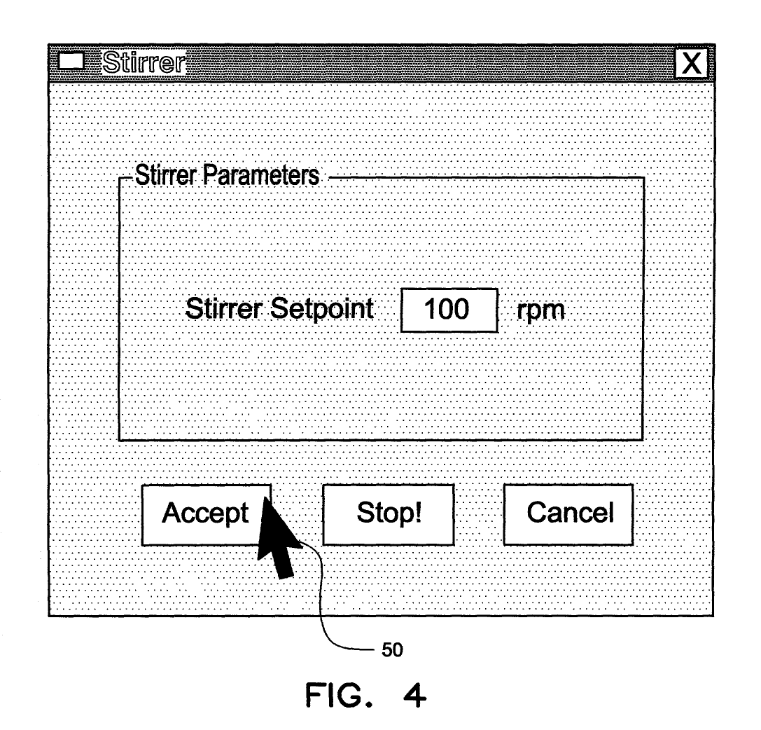

All laboratory devices depicted on the desktop may be controlled by clicking on the control “button” (i.e., selectable option) associated with that device (e.g., the “pH Control” button 39, the “Feed 1 Control” button 41, the “Feed 2 Control” button 43, the “Stirrer Control” button 45, or the “Temperature Control” button 47). A pointer 50 visible on the desktop 32 may be controlled with the mouse, thereby allowing the user to click on the desired device/buttons. For example, if the user clicks on the “Stirrer Control” button 45, a dialog box will be displayed showing the stirrer parameters, as shown in FIG. 4. Thus, if the user wants to change the stirrer speed from 50 rpm to 100 rpm, the user clicks the display of the stirrer setpoint rpm in the dialog box and, using the keyboard, inserts the number “100” in place of the number “50.” Next, the user clicks on the “Accept” button at the bottom of the dialog box, and the stirrer immediately starts spinning at the new rate of 100 rpm. Of course, any number of different means may be used to allow the user to enter operating parameters and the system to receive such parameters related to a particular laboratory device. For example, representative device control panels could be used to allow the user to enter the operational parameters or graphical parameter representations could be used to adjust parameters (e.g., clicking on a representative stirrer could adjust the stirrer spin speed). As a further example, operational parameters could be keyed into the system, adjusted by a click of the mouse, or entered vocally.

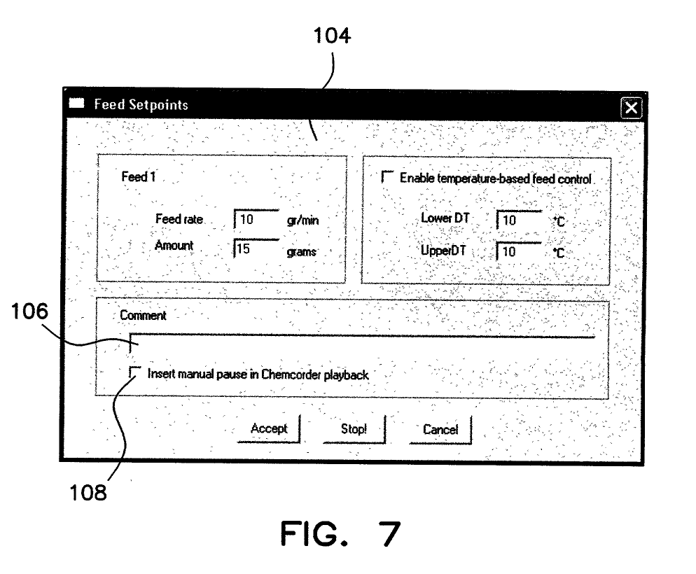

Similarly, the user may click on one of the “Feed Control” 41 or 43 (or “pH Control” 39) buttons to control the feed rate and amount of liquid product to be fed to the reactor. After clicking on the “Feed Control” buttons, a dialog box appears, similar to that shown in FIG. 7, allowing the user to insert a desired feed rate (in weight or volume per minute) and a desired feed amount (in total weight or volume). Again, after clicking the “Accept” button at the bottom of the dialog box, the workstation will begin the desired feed.

The desktop also provides for temperature control of the reactor. After clicking on the “Temperature Control” button 47, a dialog box appears, allowing the user to choose the desired temperature measurement to control. After choosing a desired temperature or temperature range, the user also provides a ramp rate which defines the rate at which the temperature will change (e.g., ° C./min). After completing the information in the dialog box, the user clicks the “Accept” button at the bottom of the dialog box and the workstation immediately begins to control the identified temperature based upon the users instructions. When the temperature control determines that the temperature is not in the preferred range, a pump will cause thermal control fluid to flow into the jacket inlet 23, through the jacket 24, and out the jacket outlet 25, thereby pumping heated or cooled fluid in to the jacket and respectively heating or cooling the reactor contents surrounded by the jacket 24.

With reference again to FIG. 3, the information presented on the overview screen 34 continuously changes based upon actual experiment conditions. For example, the “Feed 1” data box 90 is periodically updated to show the actual amount of fluid that has been fed through the Feed 1 pump. Also, the “Reactor Contents” data box 98 keeps track of the total volume of fluid in the reactor while the “Reactor Conditions” box 48 keeps track of the reactor temperature, pressure and pH. If the condition of the reactor reaches a certain threshold, a warning will be sounded or displayed on the desktop. For example, if the volume of reactor contents becomes dangerously high, an alarm sounds or a message appears on the screen warning the user to avoid over-filling the reactor. Similarly, if the reactor contents reach a threshold temperature, making the reactor unstable, a warning will be sounded or displayed, warning the user to decrease the temperature of the reactor contents.

In addition to fully automated experimentation, the desktop also allows the user to note a manual action taken by the user, such as the addition of a compound manually added to the reactor during the experiment. In this situation, the user clicks on the “Log Comment” button 52 provided on the overview screen 34. After clicking this button 52, the user is provided with a dialog box that asks the user to insert information about some manual action, such as the name of the compound entered and the amount. This feature allows the system to completely log all steps taken by the user during any given experiment, whether controlled from the desktop or manually input by the user.

A report of data showing information logged by the system 10 during the experiment is available to the user by clicking one of the “Report” buttons 54 on the desktop. These “Report” buttons provide the user with various information, including a list of all actions taken during a particular experiment, tabulated or graphical data about various conditions at different times during the experiment, and information about instruments used during the particular experimental process.

Recipe Programming and Unattended Operation

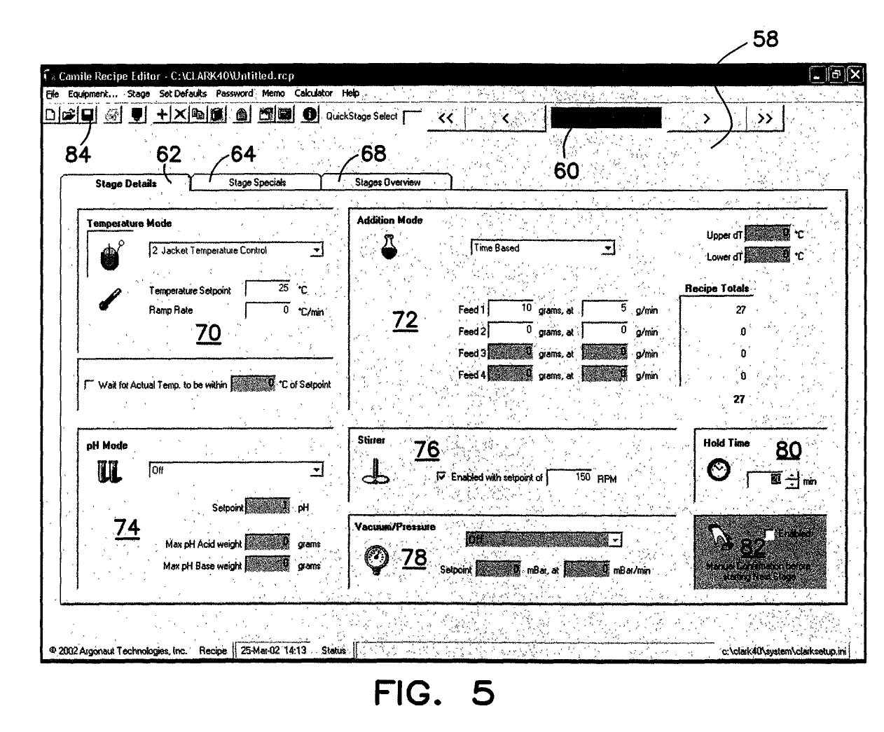

If the user desires, the system 10 may be pre-programmed to complete all steps of an experiment automatically, thereby allowing the experiment to be conducted unattended. By clicking on the “Menu” button 56, the user is presented with a “Recipe Editor” option (not shown). After clicking the “Recipe Editor” button, the user is presented with a recipe editor 58. The recipe editor 58 is a tool for programming an experiment to be performed automatically by defining a “recipe” (i.e., a series of steps to be followed to accomplish a desired result). The recipe is saved as an executable computer program that can be played using the system software. A preferred embodiment of the recipe editor 58 is shown in FIG. 5. As shown in FIG. 5, the preferred embodiment of the recipe editor includes a “Stage Details” tab 62, a “Stage Specials” tab 64, and a “Stage Overview” tab 68. Each tab provides different options to the user concerning the recipe.

Under the “Stage Details” tab 62, the recipe editor 58 is designed to set up the automated experiment as a series of steps or stages. A stage indicator 60 is provided on each screen of the recipe editor on the top right of the screen. The stage indicator shows an indication of the stage as well as arrows for maneuvering between stages. The user programs each stage of the recipe under the “Stage Details” tab, and by using the stage indicator to maneuver between stages. Each screen under the “Stage Details” tab includes a variety of icons representative of various operations (e.g., temperature control 70, addition of liquids 72, pressure control 78, pH control 74, stirring 76, etc.). The user identifies a desired action in each stage by inputting performance information in the boxes associated with each icon. For example, if the user wants to start the experiment by setting the reactor temperature to 25° C. for at least 20 minutes, the temperature set point of 25° C. is indicated in temperature mode box 70 and a hold time of 20 minutes is indicated in the hold time box 80. After identifying this first stage, the user then moves to the next stage by pressing the “>” arrow in the stage indicator 60. In the next stage, the user programs an additional step to be carried out, such as adding a new chemical through the “addition mode” box 72 or stirring the reaction through the “stirrer” box 76. When additional stages are added, the total number of stages in the experiment are shown in the stage indicator 60. For example, in FIG. 5, a seven stage experiment has been created and the first stage of the experiment is displayed in under the “Stage Details” tab. The user can move between stages by clicking the arrows to the right and left of the indicated stage in the stage indicator 60. By moving through the experiment stage-by-stage, the user defines the complete experiment, breaking down the experiment to define how the equipment and laboratory devices should function in each stage.

In addition to automated stages, the user may program a manual stage. This is done by clicking the “enabled” button in the manual confirmation box 82, and inserting instructions on the manual step to be taken by the user. This feature is especially useful when solids are to be added to the reactor during an experiment. For example, if 10 grams of NaCl is to be added to the reactor in a given stage, the user can note this as a stage in the recipe editor and note that manual confirmation is required before moving to the next stage. Thus, when the workstation automatically replays the recipe, a confirmation box will appear asking if 10 grams of NaCl has been added to the reactor. The confirmation box will include “yes” and “no” buttons the user may click in response. The workstation will not proceed with the experiment until the user makes a positive response that the NaCl has been added. Of course, the recipe programmer must recognize that manual confirmation steps can not be used if he/she desires to conduct a fully automated experiment with no user present to oversee the experiment.

The “Stage Specials” tab 64 allows the user to customize certain functions associated with different stages of the programmed experiment. For example, the “Stage Specials” tab provides for experiment termination conditions (e.g., excessive pressure, temperature, etc.), data logging rates (i.e., snapshot of experiment conditions taken at a periodic rate), and special alarm settings (e.g., excessive pressure, temperature, etc.).

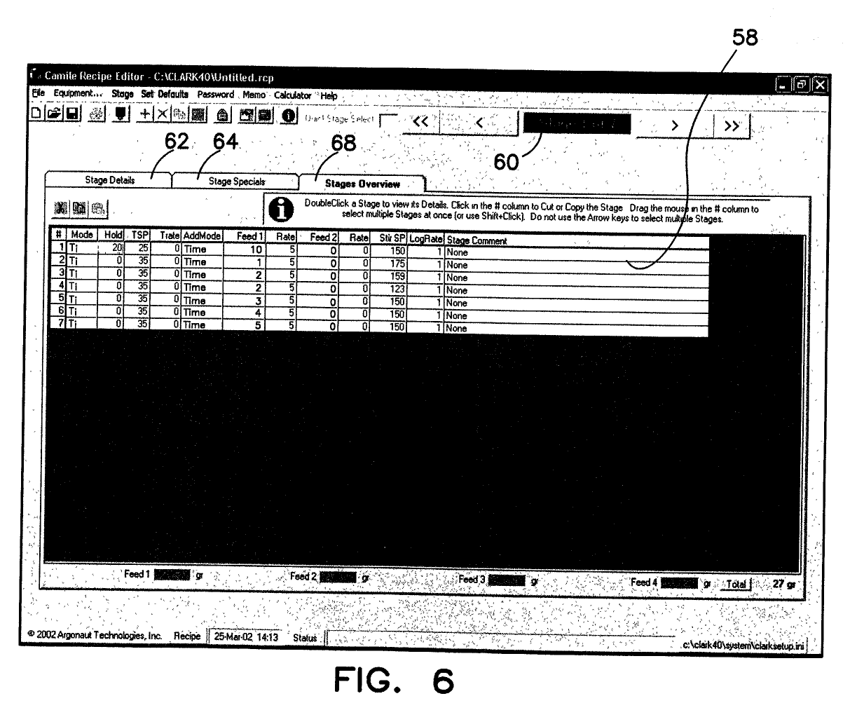

The “Stages Overview” tab 68 allows the user to review the entire experiment in a single spreadsheet format, such as that shown in FIG. 6. The “Stages Overview” tab 68 allows the user to see stages next to each other in tabular fashion, allowing the user to view the entire experiment on a single page, line-by-line. If the user sees any problems with the experiment set-up or desires changes in any particular stage, he or she can double click on the line showing the particular stage and be transferred to the “Stage Details” tab for that stage. At the “Stage Details” tab, the user may make any required modifications to the experimental set-up. Alternatively, the user may make modifications to different stages directly from the “Stages Overview” tab 68 by single clicking on an particular information item and changing the entry for that item. For example, if the user wants to change the hold time in step one from 20 to 25 minutes, the user can click on the “20” in line one and enter the new data in place of the old.

After all stages of a recipe are entered into the system, the recipe is saved by clicking the “Save” button 84. Thereafter, the created recipe is saved and the user is returned to the overview screen 34.

At the overview screen 34, the user may execute the recipe by clicking on the menu button 35. Clicking on the menu button 35 will provide the user with a number of options, one of which being an “Execute Recipe” button (not shown). Choosing this “Execute Recipe” button 66 will allow the user to choose from a list of recipes saved in the system. After the user chooses a recipe, the workstation will confirm that all laboratory devices required to execute the chosen recipe are connected to the system. If all required laboratory devices are not connected, the user will receive an error message informing the user that the required devices to execute the recipe are not properly connected. Also, before starting the experiment, the system will request confirmation that the reactor 20 has been filled with any required starting materials. Finally, before starting the experiment, the system will ask the user when he or she wants the experiment to begin. The user generally has the ability to start the experiment immediately or at a predefined time. For example, if the user wants an experiment to start in the middle of the night, the user can instruct the workstation to start the experiment at that time.

After an experiment is concluded using a recipe, several reports about the experiment are available for viewing. First, a recipe report showing each of the experimental steps taken during the experiment is available for viewing. Second, an experiment log, showing conditions as recorded at periodic times during the experiment is available. Also, trends reports are available that allow the user to view information in graph form, such as temperature vs. time and pH vs. time. Furthermore, an equipment report is available, listing all of the equipment that was used to perform an experiment pursuant to a particular recipe.

The overview screen 34 also provides the user with the ability to edit any recipes saved in the system. This option is available by clicking the menu button 35, which presents the user with an “Edit Recipe” option (not shown). By clicking the “Edit Recipe” button, the user is presented with a list of recipes saved in the system. After the user chooses a recipe, the recipe information is presented in the recipe editor and the recipe may be edited in the recipe editor, as described above.

Automatic Recording Feature

Another option available to the user of the workstation is to record an experiment as it is conducted in real-time so that the experiment can be automatically replayed at a later time. This feature allows a user to program a recipe by actually going through a series of experimental actions as opposed to programming a recipe in advance using the “Recipe Editor.”

Referring to FIG. 3, in order to record an experiment, the user activates the record option by simply clicking the “Record” button 100 provided on the overview screen 34 before starting an experimental process. Of course, any number of different means may be used to activate the record option, including voice activation, keyboard entry, activation of a related P/O device or some other activation method. Regardless of the means used to activate the record option, the record option is preferably provided through the graphical user desktop using a button on one of the screens, a pull down menu or on-screen instructions to the user describing how to activate the record option. After selecting the record option, the user then conducts an experiment from the overview screen by choosing various control buttons and instructing the laboratory devices to take certain actions, as described above under the heading “Real Time Experiment Control.” As the user conducts the experiment, each instruction given by the user is automatically recorded by the microprocessor in a recipe file and stored in the controller or controller module. The stored file is automatically named based on the date and time it was created. In addition to recording specific actions of the laboratory devices, other information about the experiment is also recorded. For example, times between instructions are recorded. If the user ends a process prematurely, that is also recorded and made part of the recipe. In short, the system 10 stores all information required to duplicate an experiment as conducted by the user. When the user has taken all desired experimental steps to be recorded, the “Record” button is clicked again to deactivate the record option and end the recorded session. At this time, the user has the choice of storing the file under a different file name than the name automatically assigned to the file.

A user/chemist will typically use the “Record” feature when there is a chance that he or she will want to repeat the experiment about to be conducted. The “Record” feature allows the user to actually program an experiment by conducting an ad hoc experiment, improvising each step of the experiment in an attempt to achieve a desired result. The user may then automatically replay the experiment without having to take additional steps to program the experiment into the system. For example, a chemist may want to take a certain chemical composition and change some property of the composition (e.g., boiling point, color, etc.) through some manipulative process involving various steps (e.g., the addition of other chemical agents, heat, pressure, etc.) to be determined extemporaneously. After achieving a desired result through such a process, the chemist may not remember every step taken to get to the desired result. However, if the chemist used the “Record” feature, a recipe has been automatically created, and the experiment can be automatically reproduced, without additional work by the chemist or a third party and without the chemist's presence to monitor replay of the experiment. This frees the chemist to do other important jobs and take other actions without having to try to reproduce past experiments or having to program a recipe for automatic reproduction. Thus, the “Record” feature of the system automatically records all experimental steps taken during a real-time experiment, and creates a recipe that may be run to automatically reproduce past experimental results.

As shown in FIG. 3, a “Pause” button 102 is provided next to the “Record” button 100. The “Pause” button 102 will allow the user to take actions that are not recorded or omit long periods of inactivity from the recorded recipe. For example, the user may decide that he wishes to add a particular chemical to the reactor in the current experiment, but does not want the recorded recipe to show this step. To omit the step from the recorded experiment, the user clicks on the “Pause” button 102, adds the chemical feed from the desktop, and then clicks the “Pause” button again to return to recording. Likewise, if the user wants to take a break and not have the period of inactivity recorded in the recipe, the user may click the “Pause” button 102 upon leaving for the break. Upon return, the user may click the “Pause” button 102 again, and the system will return to recording all actions taken during the experiment and related times for each action.

In addition to the ability to pause a recording so that certain actions or periods of inaction do not appear on the playback, the user of the system 10 has the ability to add a manual pause and associated comment into the recipe so that playback of the experiment is temporarily suspended until the user responds the recorded comment. A manual pause may be programmed in the playback of the experiment by using one of the laboratory device control buttons (e.g., 39, 41, 43, 45, 47, etc.). For example, if the user clicks the “Feed 1 Control” button 41, a dialog box 104 will be provided as shown in FIG. 7. The dialog box not only allows the user to insert a desired feed rate and amount for the step, it also allows the user to enter a comment and note that a manual pause should be inserted before the step is carried out. Thus, if a particular experiment requires the user to add 25 grams of NaCl to the reactor and then start a feed from the Feed 1 device, the user can note this in the comment box 106 and indicate in the check box 108 that a manual pause should be included in playback before conducting the Feed 1 step. Of course other means than those described above may be used for entering comments and the manual pause, including, without limitation, voice activation and entry.

With a comment and manual pause entered, playback of the experiment will cause a dialog box to appear showing the comment and requesting a manual confirmation before continuing. Thus, if the recorded comment associated with the manual pause is “add 25 grams of NaCl before continuing,” playback of the experiment will include a dialog box that shows this comment and then asks the user to indicate by clicking a “yes” or “no” button whether the comment has been read and it is OK to continue the experiment. Manual pauses may also be programmed by clicking the “Log Comment” button 52. Clicking the “Log Comment” button 52 results in a dialog box appearing along with a comment entry line and manual pause check box, similar to that shown in FIG. 7, that allows the user to enter a comment and note that a manual pause should be inserted in playback of the experiment. Thus, the manual pause included with the automatic recording feature of the present invention allows the user of the system 10 to confirm that manual actions taken by the user during his or her experiment will also be included in the experiment when the experiment is replayed.

In operation, the user/chemist must decide whether to use the “Record” feature at the start of an experimental process. When using the “Record” feature, the user first connects the required laboratory equipment and prepares the required chemicals in appropriate containers, noting the initial set-up using the control software screen. Once set up is complete and noted in the computer, the chemist presses a “Record” button on the control software screen. Pressing the record button causes the system to note the initial set-up requirements and prepare to build a recipe based on the upcoming actions. Next, the chemist proceeds with the experiment using the graphical user desktop 32, and the system automatically records every action made by the chemist. For example, if the chemist heats up the reactor during the experiment, the system will note the addition of heat and at what step and time to add the heat. If the chemist adds a chemical to the reactor, the system will note the addition of a chemical, along with the sequence and timing of adding the chemical. The complete experiment results are recorded in a recipe that can be automatically duplicated to reproduce previously achieved results. The record feature saves the user from having to manually program a recipe because the system automatically recorded every action taken in recipe format after the “Record” button 100 was pressed.

Once the experiment is complete and recorded by the system as a recipe, it is available for replay. To replay a recipe, the user simply selects the recipe from the list of recipes as described above under the heading “Recipe Programming and Unattended Operation.” During replay of the recipe, the system automatically duplicates the previously conducted experiment. The duplicated experiment is conducted by replaying the steps of the recorded experiment in the same order and with the same timing, with the exception that the system provides for removal or insertion of certain periods or steps. For example, manual pauses may be included in the replay involving steps that the system can not complete automatically (such as addition of a special chemical in granular form). In this situation, the user/chemist conducting the experiment is prompted to take the manual step. After the manual step is complete, the chemist then confirms that the step is complete by an appropriate response to the system. In this manner, the system provides a recipe-recorder that will record every step of an experiment by a chemist and allow that experiment to be automatically replayed without the need for additional manual programming by the chemist as traditionally accomplished through the use of a recipe builder/editor or similar programming device.

In addition to the above, recipes recorded through the system may be edited, just as any other recipe saved in the system. To do this the user selects the menu button 35, which presents the user with an “Edit Recipe” option (not shown). By clicking the “Edit Recipe” button, the user is presented with a list of recipes saved in the system. After the user chooses the recorded recipe, the recipe information is presented in the recipe editor and the recorded recipe may be edited by the user.

Although the present invention has been described in considerable detail with reference to certain preferred versions thereof, other versions are possible. For example, various screens and dialog boxes described herein could be configured significantly different from the arrangement disclosed herein. Furthermore, the processes and steps required to record an experiment as disclosed herein could also be significantly altered without departing from the scope of the present invention. As another example, additional or different laboratory devices, reactors, and hardware configurations could be used instead of those disclosed herein. Therefore, the spirit and scope of the appended claims should not be limited to the description of the preferred versions contained herein.

What is claimed is:

1. A method of operating an automated chemistry system having a graphical user desktop operable to control a plurality of laboratory devices and the actions of the plurality of laboratory devices with respect to a reactor, the method comprising the steps of:
a. activating a record option;
b. conducting an initial laboratory experiment by controlling the plurality of laboratory devices from the graphical user desktop such that each of the plurality of laboratory devices take actions with respect to the reactor;
c. automatically recording the actions of each of the laboratory devices with respect to the reactor during the initial laboratory experiment in a computer program and saving the computer program;
d. de-activating the record option;
e. executing the computer program such that the recorded actions of each of the laboratory devices are replayed in the same order that they occurred during the initial laboratory experiment to thereby automatically duplicate the laboratory experiment.

2. The method of step 1 wherein the recorded actions of each of the laboratory devices are replayed at the same timing that they occurred during the initial laboratory experiment.

3. The method of step 1 further comprising the step of choosing the computer program from a list before the step of executing the computer program.

4. The method of claim 1 wherein the record option is provided through the graphical user desktop.

5. The method of claim 1 further comprising the step of activating a pause option provided through the graphical user desktop after activation of the record option.

6. The method of claim 5 further comprising the step of taking an unrecorded action not saved in the computer program by controlling one of the plurality of laboratory devices after the step of activating the pause option.

7. The method of claim 6 further comprising the step of deactivating the pause option and thereby causing subsequent actions taken by the laboratory devices to be recorded and saved by the computer program.

8. The method of claim 1 further comprising the step of logging a comment and requesting an associated manual pause when the computer program is executed.

9. The method of claim 8 wherein the logged comment is displayed during the step of executing the computer program and execution of the computer program is paused until an indication is provided to continue execution of the computer program.

10. An automated chemistry system for controlling a plurality of laboratory devices used to conduct an experiment that produces a desired result, the automated chemistry system comprising:
a. a controller connected to the plurality of laboratory devices;
b. an input/output device connected to the controller;
c. a graphical user desktop accessible through the input/output device for controlling the actions of the plurality of laboratory devices, the graphical user desktop comprising
(i) representations of the plurality of laboratory devices;
(ii) means for receiving operation parameters for each of the plurality of laboratory devices; and
(iii) means for automatically recording the actions of the plurality of laboratory devices during the experiment and automatically storing the actions in a computer program that is executable to automatically replay the recorded actions of the plurality of laboratory devices and thereby reproduce the desired result.

11. The system of claim 10 further comprising a means for choosing the computer program and causing the computer program to be executed.

12. The system of claim 10 wherein the recorded actions of each of the plurality of laboratory devices are replayed in the same order and at the same intervals that they occurred during the initial laboratory experiment.

13. The system of claim 10 wherein the means for automatically recording the actions of the plurality of laboratory devices is activated by selecting a record button on the graphical user desktop.

14. The system of claim 10 further comprising a means for pausing the means for recording the plurality of laboratory devices.

15. The system of claim 14 wherein the means for pausing is activated by selecting a pause button on the graphical user desktop.

16. The system of claim 10 wherein the graphical user desktop further comprises a means for logging a comment for display when the computer program is executed.

17. The system of claim 16 wherein the graphical user desktop further comprises a means for requesting an manual pause associated with the logged comment such that the manual pause occurs when the computer program is executed and the logged comment is displayed.

18. The system of claim 10 further comprising a means for editing the computer program.

19. The system of claim 10 wherein the means for receiving operation parameters delivers received operation parameters to the controller to control the plurality of laboratory devices during the experiment.

20. A recipe recorder for recording the actions of plurality of laboratory devices during an experiment and automatically replaying the recorded actions, the recipe recorder comprising:
a. a means for entering operation parameters for each of the plurality of laboratory devices;
b. means for causing each of the plurality of laboratory devices to take actions during an experiment based on the operation parameters;
c. means for automatically recording the actions of the plurality of laboratory devices during the experiment and automatically storing the recorded actions in a recipe;
d. means for automatically replaying the experiment by executing the recipe.

21. An automated chemistry system for controlling a plurality of laboratory devices used to conduct an experiment that produces a desired result, the automated chemistry system comprising:
a. a controller connected to the plurality of laboratory devices;
b. an input/output device connected to the controller;
c. a graphical user desktop accessible through the input/output device for controlling the actions of the plurality of laboratory devices, the graphical user desktop comprising
(i) representations of the plurality of laboratory devices; and
(ii) means for receiving operation parameters for each of the plurality of laboratory devices; and
d. a record device wherein activation of the record device causes the actions of the plurality of laboratory devices during the experiment to be automatically recorded and stored in a computer program that is executable to automatically replay the recorded actions of the plurality of laboratory devices and thereby reproduce the desired result.

22. The automated chemistry system of claim 21 wherein the means for receiving operation parameters delivers received operation parameters to the controller to control the plurality of laboratory devices during the experiment.

23. The automated chemistry system of claim 21 wherein the record device is provided through the graphical user desktop.
